(19) United States
(12) Patent Application Publication
(10) Pub. No.: US 2009/0102612 A1
(43) Pub. Date: Apr. 23, 2009

(54) RFID RECORD AND VERIFICATION SYSTEM AND METHOD OF USE FOR PATIENT UNDERGOING RADIATION THERAPY

(75) Inventors: Geoffrey Dalbow, Eagle, CO (US); Michael Ray Leach, Tulsa, OK (US); Willet F. Whitmore, III, Longboat Key, FL (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: CIVCO MEDICAL INSTRUMENTS CO., INC., Kalona, IA (US)

(21) Appl. No.: 12/250,087

(22) Filed: Oct. 13, 2008

Related U.S. Application Data
(60) Provisional application No. 60/979,941, filed on Oct. 15, 2007.

(51) Int. Cl. H04Q 5/22

(52) U.S. Cl. 340/10.4

(57) ABSTRACT

A system and method for providing radiation therapy to a patient is disclosed. The system includes at least one RFID tagged component, e.g., a patient positioning device, to be used when the patient is to be given radiation therapy treatment. The at least one component is specifically selected for use with the patient. The RFID tag holds information relevant to the patient. The tag is interrogated by a reader to produce a signal used by an associated computer system to verify the patient and component location and presence in the room where the treatment is to be given. The system and method enables one to determine the location of each patient, selected facility personnel and all the components for a particular patient's treatment In addition the system and method enables one to determine the time the patient and/or staff member and/or component spends at a given location for a particular treatment.

### CROSS-REFERENCE TO RELATED APPLICATIONS

This application claims priority from U.S. Provisional Application Ser. No. 60/979,941, filed on Oct. 15, 2007, entitled RFID Record and Verification System and Method of Use for Patient Undergoing Radiation Therapy, which application is assigned to the same assignee as this application and whose disclosure is incorporated by reference herein.

### BACKGROUND OF THE INVENTION

This invention relates to systems and methods for providing radiation therapy to patients, and more particularly to a systems and methods for ensuring that various components selected to be used with a patient undergoing radiation therapy at a facility are in fact being utilized and that the patient, appropriate staff and components needed to treat the patient can be tracked and located within the facility. The system also can provide temporal and local information for examining and improving patient and workflow within the treatment process.

Asset tracking of medically related items, e.g., surgical items, EKG or other patient monitors, pharmaceuticals, blood, etc., is commonly accomplished through use of a bar coded tag or radio frequency identification (RFID) tag that is affixed to the item. A reader is provided to interrogate the item to read the tag and ultimately to account for the item being tracked. Varian Medical Systems, Inc. and Impac Medical Systems, Inc., each provide systems making use of bar coded tags and associated readers and computer software for tracking such items. As will be appreciated by those skilled in the art, the drawback of use of bar-coded tags is that the reader must be manually brought into close proximity to the tag (or the item bearing the tag brought into close proximity to the reader) to effect the reading of such tags and provides no temporal or local information for tracking or workflow analysis. RFID technology offers the advantage that scanning of the tagged items can be accomplished automatically from a distance by merely bringing the RFID tagged item into an area in which an RFID transponder is located, whereupon an interrogation signal produced by the transponder results in the tag sending back a response signal to the transponder, which response signal provides patient equipment or personnel specific, temporal and location information, about the tagged item. Another important attribute of RFID systems is that a number of tags can be interrogated simultaneously. For example, many RFID systems possess the ability to readily discriminate between tags which are close to each other utilizing known anti-collision algorithms. Thus, multiple tags may be readily identifiable; a feature not readily accomplished using bar codes and will provide workflow efficiencies not found with bar code systems.

Examples of patents and patent applications making use of RFID technology for tracking medical items are the following: U.S. Pat. Nos. 6,861,954 (Levin), 6,980,111 (Notle), 6,983,884 (Auchinleck), 6,998,541 (Morris et al.), 7,019,650 (Volpi et al.), 7,142,118 (Hamilton et al.) and U.S. Published Application Nos.: 2006/0066453 (Homanfar et al.), 2006/0065713 (Kingery), 2006/0119481 (Tethraki et al.) and 2004/0008123 (Carrender et al.)

While the foregoing systems and methods may be generally suitable for their intended purposes, they do not address the needs of the medical field for a system and method for locating and ensuring that the patient and the various components to be used in a radiation therapy procedure to be performed on a patient be the particularly selected components for that treatment. The subject invention addresses that need. In addition, the subject invention also addresses the need to ensure that the personnel and components needed to treat the patient can be tracked and located within the radiation therapy facility, while also providing temporal and local information needed to examine and improve patient treatment and workflow within the treatment process. Moreover, since the information regarding the patient, staff and components to be used for treatment of the patient is provided by the system of this invention in real-time, the subject invention can play a crucial role to achieve the goal of “fail-safe” patient treatment and treatment delivery.

### BRIEF SUMMARY OF THE INVENTION

According to one aspect of this invention a system is provided for providing at least one radiation therapy treatment to a patient in a facility by means of a radiation therapy apparatus. The system basically comprises at least one component specifically selected for use by the patient when undergoing the at least one radiation therapy treatment, a first wireless device and a database in a computer system. The at least one component has a RFID tag secured thereto and that tag is arranged to hold information relevant to the specific component. The first wireless device comprises a transmitter and a receiver, with the transmitter being arranged for sending a wireless signal into the area of the facility at which the radiation therapy apparatus and the at least one component are located. The RFID tag of the at least one component is arranged to transmit a wireless signal representative of the at least one component in response to the wireless signal from the transmitter. The receiver is arranged for wirelessly receiving the wireless signal from the RFID tag of the at least one component and providing a signal in response thereto. The computer system is coupled to the first wireless device. The database includes information about the patient and the at least one component. The computer system is arranged to utilize the database and the signal from said receiver in order to determine if said at least one component is present to enable the desired radiation therapy treatment to be given to the patient.

In accordance with another aspect of this invention the facility has at least one other room in which the at least one component can be located, and wherein the system additionally comprises a second wireless device, similar to the first wireless device. The receiver of the second wireless device is arranged for wirelessly receiving the wireless signal from the RFID tag of the at least one component and providing a signal in response thereto. The computer system is arranged to utilize the database and the signals from said receivers of said first and second wireless devices to determine the location of the at least one component in either of the rooms of the facility and/or the temporal status of the at least one component in either of the rooms of the facility.

In accordance with another aspect of this invention there is provided a method of determining if at least one predetermined component has been provided with a patient to enable the patient to undergo at least one radiation therapy treatment using that component in a predetermined room in a facility. The method entails providing at least one component specifically selected for use with the patient when undergoing the treatment. The at least one component has a RFID tag fixedly secured to it that is arranged to hold information relevant to that component. A first wireless device is provided and comprises a transmitter and a receiver. The transmitter is arranged for sending a wireless signal into the room of the facility at which the radiation therapy apparatus is located to cause said RFID tag of the least one component if located therein to transmit a wireless signal representative of it. The receiver is arranged for wirelessly receiving the wireless signal from the RFID tag of the at least one component and provides a signal in response thereto. A database in a computer system is provided coupled to the receiver. The database includes information about the patient and the at least one component. The database and the signal from said receiver are utilized in the computer system so that the computer system can determine if the at least one component has been provided in the predetermined room to be used with the patient when the patient will be undergoing said radiation therapy by the radiation therapy apparatus.

In accordance with another aspect of this invention the facility has at least one other room in which the at least one component can be located, and wherein the method additionally comprises providing a second wireless device, similar to the first wireless device. The receiver of the second wireless device is arranged for wirelessly receiving the wireless signal from the RFID tag of the at least one component and providing a signal in response thereto. The computer system is arranged to utilize the database and the signals from the receivers of said first and second wireless devices to determine the location of the at least one component in either of the rooms of the facility and/or the temporal status of the at least one component in either of the rooms of the facility.

In accordance with another aspect of this invention there is provided a method of tracking a patient in a facility at which the patient will be given at least one radiation therapy treatment by a radiation therapy apparatus located in a room of the facility. The method entails providing a RFID tag on the patient. The RFID tag is arranged to hold information relevant to the patient therein. A first wireless device is provided comprising a transmitter and a receiver. The transmitter is arranged for sending a wireless signal into the room of the facility to cause the RFID tag on the patient to transmit a wireless signal representative of the patient. The receiver is arranged for wirelessly receiving the wireless signal from the RFID tag on the patient and providing a signal in response thereto. A database in a computer system is provided coupled to the receiver. The database includes information about the patient and the room of the facility. The database and the signal from the receiver are utilized in the computer system so that it can determine the location of the patient in the room of the facility and/or the temporal status of the patient in the room of the facility.

In accordance with another aspect of this invention the facility has at least one other room in which the patient can be located, and wherein the method additionally comprises providing a second wireless device, similar to the first wireless device. The receiver of the second wireless device is arranged for wirelessly receiving the wireless signal from the RFID tag on the patient and providing a signal in response thereto. The computer system is arranged to utilize the database and the signals from the receivers of said first and second wireless devices to determine the location of the patient in either of the rooms of the facility and/or the temporal status of the patient in either of the rooms of the facility.

In accordance with another aspect of this invention there is provided a method of tracking a staff person in a facility at which a patient will be given at least one radiation therapy treatment by a radiation therapy apparatus located in a room in the facility. The method entails providing a RFID tag on the staff person. The RFID tag is arranged to hold information relevant to the staff person therein. A first wireless device is provided comprising a transmitter and a receiver. The transmitter is arranged for sending a wireless signal into the room of the facility to cause the RFID tag on the patient to transmit a wireless signal representative of the staff person. The receiver is arranged for wirelessly receiving the wireless signal from the RFID tag on the staff person and providing a signal in response thereto. A database in a computer system is provided coupled to the receiver. The database includes information about the staff person and the room of the facility. The database and the signal from the receiver are utilized in the computer system so that it can determine the location of the staff person in the room of the facility and/or the temporal status of the staff person in the room of the facility.

In accordance with another aspect of this invention the facility has at least one other room in which the staff person can be located, and wherein the method additionally comprises providing a second wireless device, similar to the first wireless device. The receiver of the second wireless device is arranged for wirelessly receiving the wireless signal from the RFID tag on the staff person and providing a signal in response thereto. The computer system is arranged to utilize the database and the signals from the receivers of said first and second wireless devices to determine the location of the staff person in either of the rooms of the facility and/or the temporal status of the staff person in either of the rooms of the facility.

### BRIEF DESCRIPTION OF SEVERAL VIEWS OF THE DRAWINGS

The invention will be described in conjunction with the following drawings in which like reference numerals refer to like parts and wherein:

FIG. 1 is a block diagram of an RFID system constructed in accordance with one aspect of this invention shown in use in an exemplary medical facility, e.g., hospital, out-patient center, etc., having at least one treatment room including a radiation therapy apparatus (e.g., a LINAC) as well as other rooms in which various components for use with the radiation therapy apparatus, as well as patients and personnel of the facility may be located; and

FIG. 2 is an illustration of an exemplary radiation therapy apparatus in the treatment room shown in FIG. 1, with three exemplary RFID tagged components, e.g., couchtops, which can be used with the treatment (patient support) table being shown proximate to the table.

### DETAILED DESCRIPTION OF THE PREFERRED EMBODIMENTS OF THE INVENTION

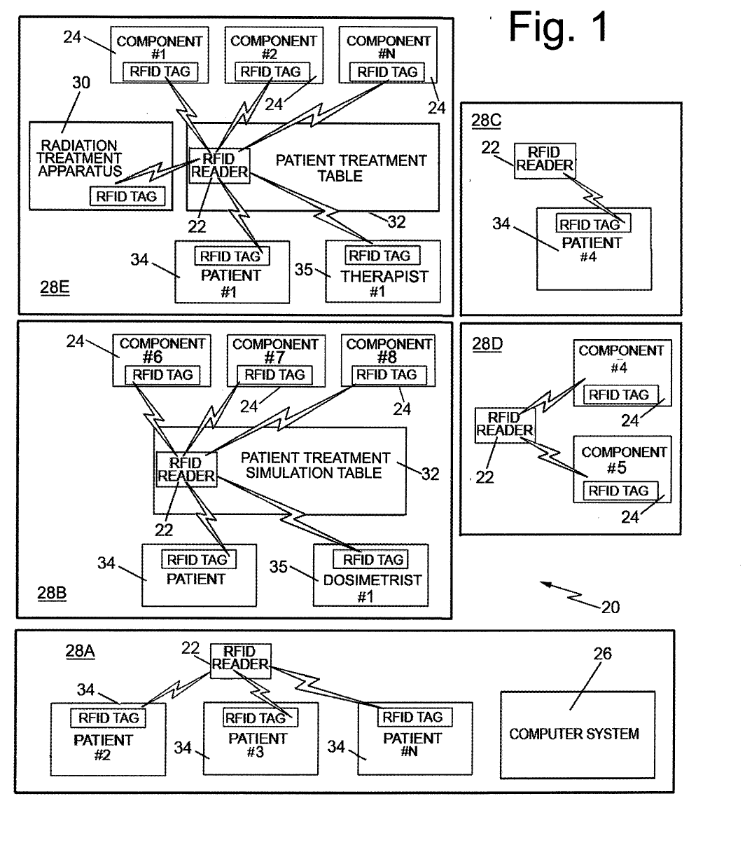

Referring now to the various figures of the drawings wherein like reference numbers refer to like parts there is shown at 20 in FIG. 1 an RFID system constructed in accordance with this invention for use in a facility providing radiation therapy treatment(s) to a patient. The RFID system 20 includes three basic components, namely, at least one transceiver including an associated antenna (collectively referred to as a “reader” 22), at least one transponder or RFID tagged component 24 and an associated computer system 26. The system is arranged to track the location of the RFID tagged component(s), as well as the patient(s) and any appropriate facility personnel throughout the facility. Moreover, the system 20 is also arranged to provide temporal information about the tagged components, patients and personnel. A description of the various types of components 24 that can be used with this system will be given later. Suffice it for now to state that the RFID tagged components shown in FIG. 1 comprise any of various items which are used or useful in connection with the therapy to be given to the patient, e.g., items to support, immobilize or hold the patient in place during the therapy.

The subject invention has particular applicability for use in any type of medical facility having at least one treatment room including a radiation therapy apparatus 30 (e.g., a LINAC) for providing radiation therapy to a patient 34 located on a patient treatment table or couch 32 by one of the facility's staff 35. Examples of such exemplary facilities are hospitals, clinics, out-patient centers, etc. The exemplary embodiment of the facility shown in FIG. 1 includes several rooms, namely, a combination reception (patient-intake) and waiting room 28A, a therapy simulation room 28B, a patient examining room 28C, an equipment/component storage room 28D, and a radiation therapy treatment room or vault 28E. It should be pointed out at this juncture that the rooms shown in the exemplary facility of FIG. 1 are merely exemplary of a multitude of types and number of rooms of a medical facility in which the subject RFID system 20 can be used. In particular, the system 20 of this invention is arranged to track various pieces of equipment and/or components 24 to be used in the treatment, the various patients 34 in the facility, as well as at least selected ones of the facility's personnel 35. To that end, as will be described later, each of the patients 34 and facility personnel 35 to be monitored/tracked by the system 20 is provided with his/her own RFID badge or tag (to be described later). In addition, each piece of equipment or component to be used with each patient is provided with its own RFID tag (also to be described).

In the exemplary embodiment shown in FIG. 1 there are three patients 34 shown in the reception or patient-intake room 28A, namely the patients designated as “Patient #2”, “Patient #3” and “Patient #N”. The designation “#N” is made to indicate that the system 20 can monitor any number of RFID tagged patients, from 1 to N. It is in the reception or patient intake room that each patient is entered into the system 20. For example, the patient may be given his/her particular RFID badge or tag and that information put into the system via reader or by keyboard or some other scanned entry. If the patient intake-area has seating the patient may be seated until the facility is ready to provide his/her treatment planning and/or treatment. That planning is typically accomplished in the simulation room 28B where a patient 34 to undergo therapy may be imaged, e.g., a CAT scan taken, and/or otherwise be initially set up in accordance the desired treatment plan by one of the facility's staff. The person typically charged with setting up the equipment to accomplish the physician's treatment plan is sometimes referred to as the dosimetrist. It is in the simulation room that the various RFID tagged components to be used with the procedure, e.g., overlays, patient supports and immobilization or holding devices, such as frames, masks, cushions, etc., are selected and placed on or in the vicinity of the patient treatment simulation table 32 by the dosimetrist or some other person on the staff of the facility so that they can be read (registered) into the system 20 by the reader 22 in that room. In the exemplary embodiment shown in FIG. 1, the simulation room 28B is shown to have one patient “Patient #5” and a facility dosimetrist, i.e., “Dosimetrist #1” located therein, along with three positioning or immobilization components 24, namely, as “Component #6”, “Component #7” and “Component #8” to be used with that patient when that patient is subsequently given his/her treatment in the treatment room 28E. Another patient 34, i.e., “Patient #4”, is shown located in examining room 28C. The treatment room 28E, which includes the radiation treatment apparatus 30 (e.g., a LINAC) and the patient treatment table 32 is shown as having another patient, i.e., “Patient #1”, in it along with a therapist, i.e., “Therapist #1” and three components, i.e., “Component #1”, “Component #2” and “Component #N”, to be used with that patient when the patient is given his/her radiation therapy. The use of the designation “#N” is to indicate that the system can be used with any number of components from 1 to N.

In the exemplary embodiment shown in FIG. 1, there are plural RFID readers 22, a respective one located in each of the rooms 28A, 28B, 28C, 28D and 28E. Each of the readers 22 is mounted in the ceiling of the room in which it is located, but could be mounted/disposed in other places, e.g., in a wall or in the floor, or at the entrance to the room. The reader, in fact, need not be part of the room. For example, at the patient check-in desk or station a desktop reader 22 can be used. Moreover, it is contemplated that the system 20 of this invention can utilize mobile or even portable readers. For example, in the treatment room or in some other room of the facility it may be desirable to have a reader movably mounted on an arm, e.g., a ceiling mounted arm, or on some other movable structure, e.g., a cart, to be able to create a live RFID reading zone wherever it would be beneficial.

In accordance with one preferred aspect of this invention the reader 22 in the treatment room 28E is preferably tuned (e.g., its antenna(s) arranged) so that it is able to read any RFID tag located at the treatment couch and in the immediately adjacent vicinity of the treatment couch, but not read any other RFID tagged components that may be in the room and located remote from the treatment couch. In fact, it is contemplated that in the case of the treatment room 22E, the RFID reader 22 be a part of the treatment couch, e.g., be located therein. That feature may enable the system 20 to not only be able to determine the presence of the desired components, but whether those components are placed properly with respect to the table in accordance with the desired treatment plan.

Each of the readers 22 of the system 20 is connected by any suitable means, e.g., a hard wired or wireless network, to the computer system 26. As mentioned earlier, the RFID tagged components shown in FIG. 1 comprise any of various items which are used or useful in connection with the therapy to be given to the patient, e.g., items to support, immobilize or hold the patient in place during the therapy. Three such components 24 are located in the simulation room 28B. Those components are designated as “Component #6”, “Component #7” and “Component #8”. A pair of components 24, designated as “Component #4” and “Component #5” are shown located in the storage room 28D.

One of the features of the system 20 is that it is arranged to ensure that all of the components 24 which are prescribed to be used with a particular patient are so used when the patient is given his/her radiation treatment. That procedure will be described later. Suffice it for now to state that each component 24 for which verification is desired is provided with its own respective RFID tag. The tag may be incorporated into the component, e.g., molded into a molded component, or may be secured to the outer or some other surface of the component. The RFID tag may be active or passive. In fact, the subject invention contemplates systems making use of a combination of active and passive tags, depending upon the particular application desired. In any case, the RFID tag is electronically programmed with certain unique information. At the very least the information that is programmed into the RFID tag is the tag's unique identifier. It may also be programmed with the identity of the component, the identity of the patient, use information, etc. The antenna of each reader 22 is arranged to emit radio frequency waves to activate or interrogate any tag within its range in order to read and/or write data to it. In turn, the RFID tag transmits data back to the reader. That data is used to interface with a database (to be described later) in the computer system 26, to carry out desired functions of the system. Since patients as well as selected staff are also provided with respective RFID tags, their location within the facility can also be monitored. Thus, the system 20 is arranged to provide information regarding the location of the tagged patients 34 in the facility, the location of the tagged facility personnel 35, and the location of the tagged components 24.

One exemplary operation of the system 20 with respect to the treatment room 28E will now be described. The reader 22 in that room generates an RF field and transmits that field through its associated antenna(s) into the room. The RF field excites the circuitry contained in the RFID tag(s) of each of the component(s) within the vicinity of the reader to cause the tag(s) to emit a signal containing the information stored in the tag(s) as well as tag location on the table. This signal is received by the receiver's antenna(s), and routed through the reader 22 to the computer system 26. The computer system analyzes this information against a set of previously stored data, locations and/or conditions, e.g., determines if all of the appropriate components for that patient for that particular treatment, as established by the predetermined treatment plan, is/are in place and in the correct place on the treatment table or couch so that the treatment can proceed according to the plan. It should be noted that the RFID reader 22 or any other part of the system may be adapted to write new data to the RFID transponder tags, for example, if a patient's treatment field is changed or altered during the treatment cycle due to prescription or field modification. The tag would be modified showing the date and new field information.

Any or all of the following kinds of data that may be included and/or collected in the database for use by the computer system of this invention: patient name, patient ID number, patient consent signature or treatment verification sign off, patient photograph, patient fingerprint, patient identifier, patient address, patient telephone number, record and verify information, diagnosis, identity (e.g., name(s)) of nurse(s) caring for the patient, identity of therapist(s) (e.g., name(s)) simulating the patient, identity of therapist(s) (e.g., name(s)) treating the patient, therapist's signature or treatment verification sign off, physician's signature or treatment verification sign off, nurse's signature or treatment verification sign off, treatment planning data, treatment alignment data, treatment device list, equipment set up data, patient positioning or indexing data, identity (e.g., name(s)) of treating managing physician(s), identification and location of treatment room, treatment number, cumulative radiation dose, hospital room number, treatment time, patient specific imaging and contour data, and patient billing information.

The ability to determine the location of tagged components within a facility should result in treatment efficiencies and reduced patient waiting time. For example, if a particular component selected for a particular patient is missing from the treatment room when the patient is in that room for treatment, the system 20 can be interrogated (i.e., the various readers in the various rooms of the facility operated) to determine where the missing component is located. If the missing component is determined to be in a particular room, e.g., a storage room, one of the facility's staff members can be dispatched to quickly retrieve it and bring it to the treatment room.

As mentioned above, each of the facility's patients 34 and some of its staff 35 may be provided with respective RFID tags to be worn or located on those persons so that they can be tracked (i.e., located) throughout the facility by the readers 22 in the various locations. Thus, the system 20 is also able to provide temporal data regarding the components, patients and staff within the facility. For example, the system can utilize the readers to determine how long a particular patient 34 is/was in the waiting room, how long a patient 34 is/was in the treatment room, how long a particular staff member takes/took to perform a particular task or is/was in a certain area, how long a particular component is/was in a particular location, etc. Such information can be extremely useful for patient and workflow analysis to increase efficiencies and treatment throughput. This, alone, should help improve patient satisfaction. Further still, the system 20 enables one to conduct asset management and potentially look at time savings and costs savings relative to a particular piece of equipment. Further yet, the system of the subject invention is particularly suitable for inclusion in what is now being called “protocol-based medicine”, where the methods of patient treatment are standardized and each component to be used in a particular treatment has to be verified for compliance to the protocol. The data generated by the system 20 can be collected over time in order to evaluate how these protocols will affect patient outcomes. Thus, the subject invention offers a valuable means for correlating treatment protocols with treatment outcomes.

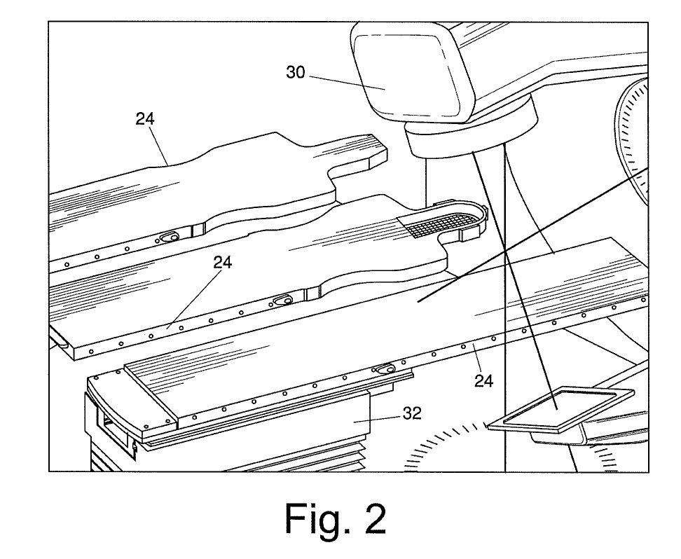

As mentioned above, the components 24 may be various items which are used or useful in connection with the therapy to be given to the patient. Those components may be consumable or non-consumable. Examples, non-consumable components which may be tagged in accordance with this invention are so-called “couchtops” and “overlays”. Couchtops and overlays are available from various sources. Some particularly effective couchtops are available from CIVCO Medical Instruments, Inc. (hereinafter “CIVCO”), the assignee of this invention. Three examples of such couchtops are shown in FIG. 2, with one being shown on the pedestal of the patient support table 32 and with the other two being shown beside the table. It will of course be apparent to those skilled in the art that only one couchtop is used at any one time on the table 32. The couchtops shown are made of carbon fiber or other materials and are indexable, i.e., they can be moved to various positions with respect to the table's pedestal and hence to the apparatus 30. This couch top position with respect to the pedestal and thus the treatment machine can be monitored by the use of the RFID tags. Overlays which can be tagged with an RFID tag in accordance with this invention are also available from various companies. CIVCO provides an overlay that serves as a radiation-friendly base for the patient on the treatment table. To that end the CIVCO overlay create less image artifacts, thereby enabling more treatment plan options. CIVCO overlays are made of carbon fiber with a foam core and include indexing options. Moreover, they come with a system for positioning devices to be fixed to the couchtop.

Fixator™ and Type-S™ Systems are non-consumable support systems available from CIVCO which can also be tagged with RFID tags in accordance with this invention. Such systems offer a high degree of stability for the head, neck and shoulders and are ideal for IMRT and conformal treatments in a 360° arc. The Type-S system features, minimal attenuation and CT-compatibility and accepts head-only or head, neck and shoulder thermoplastics. Moreover it is indexable. The Fixator Shoulder Suppression System is designed to enhance the benefits of the Type-S system. The Fixator system extends off the couchtop and includes adjustable padded positioners to gently cup the patients shoulder's, capturing and positioning them out of the treatment field. Indexed nomenclature allows for easily-recorded shoulder repositioning. Type-S head-only IMRT Reinforced Thermoplastic masks are recommended for use with this system. Head and neck baseplates are still other type of non-consumable component that can be tagged with an RFID tag in accordance with this invention. Such items are available from several sources. CIVCO provides a baseplate under the trademark Posifix® that is designed for use with a thermoplastic masking system, i.e., Posicast® thermoplastic masking system. The CIVCO baseplate is available in two types, namely, a head-only baseplate and larger T-shaped head, neck and shoulders baseplate. Both shapes are available in a carbon fiber version. An acrylic version is available for cases where the low attenuating properties of carbon fiber are not required. Another baseplate which can be tagged with an RFID tag is the CIVCO Uni-Frame® baseplate. That baseplate forms a uni-frame head and neck fixation system that provides rigid immobilization for enhanced image quality, as well as consistent patient posture through imaging, simulation and treatment procedures. The Uni-Frame® baseplate is available in carbon fiber or acrylic and features a cutout area under the headrest for visualization and treatment. Easy-to-use swivel clamps are provided for locking down a variety of thermoplastic mask options to the baseplate. CIVCO also sells another type of baseplate under the trademark Combifix. The Combifix baseboard indexes to the couchtop and combines with cushions for the accommodating the patient's feet and cushions for accommodating the patient's knees, i.e., Feetfix cushions and Kneefix cushions, respectively.

Breastboards are still another type of non-consumable component that can be tagged with an RFID tag in accordance with this invention. One exemplary breastboard available from CIVCO is constructed of carbon fiber and features carbon fiber grid treatment panels for rigid support for the bi-lateral treatment windows. This construction makes the breastboard lightweight, while being “treatment field friendly” with low attenuation coefficients. The breastboard also features a positive locking angulations system. A hip stop is provided which is indexable to prevent patients from sliding down the board.

Wingboards are yet another type of non-consumable component that can be tagged with an RFID tag in accordance with this invention. Wingboards are available from CIVCO and are constructed of durable, lightweight ABS and feature either Delrin post hand grips or the T-Grip or U-Grip handles. The CIVCO wingboards are CT compatible and indexable for enhanced reproducibility from imaging through treatment. Moreover, they are adapted to be easily attached to CIVCO breastboards.

Bellyboards are yet another type of non-consumable component that can be tagged with an RFID tag in accordance with this invention. Bellyboards are also available from CIVCO and are radiotransparent, lightweight, rigid and indexable.

Hip and pelvis immobilization systems are yet other types of non-consumable components that can be tagged with RFID tags in accordance with this invention. Such systems are sold by CIVCO under the trademark Hipfix and utilize a single sheet of thermoplastic over the entire abdomen and pelvis region. The Hipfix system accommodates both prone and supine patient setups and provides immobilization to enhance fixed fiducial targeting. The HipFix system includes a baseplate that features a cutout treatment window. The baseplate can be indexed to the couchtop.

Arm and leg positioning systems are yet other types of non-consumable components that can be tagged with RFID tags in accordance with this invention. One such system is sold under the trademark Multifix by CIVCO. That system allows arms and legs to be fixed in straight or bent positions, using small precuts of thermoplastics which are easily shaped to anatomical contours and are then fixed onto the baseplate on clearly indicated positions. The baseplate is indexable to ensure a reproducible setup and features four sets of indexing holes to offer an isocentric position of the treated extremity.

Treatment chairs are yet another type of non-consumable component that can be tagged with RFID tags in accordance with this invention. One such chair is sold under the trademark Multifix by CIVCO and provides upright positioning for specialty treatment cases or for patients who have difficulty lying horizontally for treatments. The reclining back of the chair adjusts to six positive locking positions between 65 and 90°. The back of the chair consists of a carbon fiber grid treatment window for breast, lung and thorax treatments. The chair is indexable for enhanced reproducibility and accepts several head positioning options. The chair comes with the choice of either arms-up or arms-down positioners.

Other non-consumable components that can be tagged by the system include photon, electron and proton beam compensators, stereotactic radio-surgery collimators and immobilization, treatment bolus and blocks.

Numerous consumable products to be used with radiation treatments can also be tagged with RFID tags in accordance with this invention, such as blocking trays, bolus, thermoplastics (e.g., masks), headrests, cushions, etc.

It should be apparent to one skilled in the art that the above described components are not the totality of components that can be tagged with an RFID tag to be used in the system and method of this invention. To that end, any treatment aid, positioning device or any other item which should be verified or tracked for use with the patient during, before or after treatment can be tagged with an RFID tag in accordance with this invention. Examples of such other items, include but are not limited to, patient identification (ID) cards, charts, films, chart and film jackets, patient bracelets, etc. Further still, it is contemplated that each patient at a facility may be provided with his/her own RFID tagged security container, e.g., a lockable box, bag, etc., into which the patient may put his/her personal items, e.g., clothing, valuables, etc., for safekeeping during their treatment. The system of this invention could readily track the location of each of those RFID tagged containers, thereby ensuring security of the patient's personal items.

As mentioned earlier the computer system 26 includes a database containing relevant data for the anticipated treatment. In addition, the computer system includes various operating system software and application programs for utilizing the database of collected and input data. The software in bar code-based component verification systems of Varian and Impac Medical Systems, Inc. (mentioned above), which may be referred to as “Record and Verify” software or “RV” software may be modified for use with the subject invention. The software of Impac Medical Systems Inc. is designated by it as “Extended Barcoding”. Alternatively, stand alone software developed by CIVCO may be used. In any case the software/database maintains and documents all of the prescribed treatment and equipment parameters for each individual patient treatment. The following are a few examples of data in the database: patient name, patient ID number, patient treatment position information (e.g., six degree of motion data over the course of the treatment time), treatment device set up data, record and verify information, patient treatment information, therapist(s) signature or treatment verification sign off, physician(s) signature or treatment verification sign off, patient consent signature or treatment verification sign off, nurse(s) signature or treatment verification sign off, treatment planning data, treatment alignment data, treatment device list, equipment set up data, patient positioning or indexing data, treating therapists name, treatment room, treatment number, cumulated dose, treatment time, patient specific imaging and contour data and patient billing information

The software in bar code-based component verification systems of Varian and Impac Medical Systems, Inc. (mentioned above), which may be referred to as “Record and Verify” software may be modified for use with the subject invention. The software of Impac Medical Systems Inc. is designated by it as “Extended Barcoding”. Alternatively, stand alone software developed by CIVCO may be used.

The following constitutes one exemplary use of the system 20 to provide a patient 34 with radiation therapy for destruction of a malignant brain tumor. An initial consultation with a radiation oncologist is undertaken to result in the selection of the various components 24 to be used with that treatment, e.g., the various positioning devices, masks, etc., are selected. Respective RFID numbers are encoded into the RFID tags of respective ones of those components. Those components may be custom or basic positioning or treatment related devices. In any case the components are assigned to the specific patient and that data encoded into the RFID tags and into the database of the computer system. The components are then brought into the room so that they can be interrogated by the reader 22 of the system 20 to verify that all of the required are present for the treatment. In particular, the components may be placed on the treatment table, e.g., a couchtop, mounted on that table, whereupon the reader will interrogate those components so that the system can verify that all desired components for that particular patient and treatment are in the room and available. After the clinical simulation has been accomplished treatment planning is undertaken.

During the initial patient treatment set-up (referred to as the treatment “simulation” process) the clinician will be assigning, creating and collecting the pertinent treatment set up equipment and data to be incorporation into the patient specific “treatment plan”. This data is entered into the record and verify software of the subject system either through a manual entry procedure (typing) or by scanning the specific equipment used in the initial treatment set-up or simulation that have the patient-specific RFID tags attached to them. The equipment file will be organized in the RV system and can be associated to a specific patient via a specific RFID tag set assigned for the specific patient at the time of “simulation.” The duplication of the RFID tags assigned to a specific patient at the time of simulation will be created to be attached to all equipment associated to the specific patient's treatment. These tags will be created at the time of simulation and attached to organize documentation and billing information for all of the equipment associated with that specific patient. On the first day of treatment and any subsequent treatment days the simulation patient list will be retrieved from the RV data base by interrogating a RFID tag assigned to the specific patient at the time of simulation. Interrogating the patient specific tag will bring up the treatment plan in the RV system along with the list of equipment needed to treat the patient as specified at the time of simulation. The clinician will be able to locate all the equipment needed to treat the patient prior to treatment by using the patient specific RFID signature to track down the equipment. This can be done in either of the following ways. The RV system can record the location by knowing the identification of the last RFID reader that interrogated the patient or personnel specific tag or specific piece of equipment and therefore indicating the last recorded position of the device or a department wide RFID system will be installed to track specific RFID tagged equipment throughout the treatment and simulation process. After the patient is positioned for treatment each device assigned in the specific patient (RV) list will be brought to the patient treatment couch. As the devices are passed by the RFID reader assigned to the specific treatment room and incorporated into the treatment room the RFID reader will automatically (proximity reader) read and record the device and provide a indication on the RV list of its use (check off system). The clinician will continue to go through the RV list collecting and passing the RFID reader installed in the treatment room. The RFID tagged equipment assigned to the specific patient treatment will be recorded as it is passes the treatment room RFID reader. As the equipment is incorporated into the treatment area the RFID system will read and record the device usage. The clinician will continue this process until the patient specific RV equipment list is complete. At this time the RV system will indicate that all the appropriate equipment is in use and that the proper patient is on the table and allow for the treatment to resume.

The RFID system in conjunction with the RV system will record the successful incorporation of all pertinent equipment and send an indication for proper charge capture or billing for all appropriate equipment. The RFID system can also be assigned to record the actual treatment by nature of the fact that it will record the presence of the patient and the appropriate set up of the patient equipment, and therefore can act as a billing surrogate for the treatment. Specific treatments and billing schedules can be built into the RFID signature set for the specific patient at the time of simulation. This process will be carried out on a daily bases until the patient's treatment is complete. This will provide assurance that all the appropriate RFID tagged equipment was incorporated into every day's treatment and that the patient was appropriately billed for the treatment and treatment devices used.

During the course of a patient treatment the patient may move or the treatment area may become misaligned to the treatment device do to motion, patient weight loss or gain or changes in the treatment process. This information may change the position and or equipment needed to treat the patient. The change of patient position and or treatment equipment will be recorded in the RFID RV process as defined by repeating the initial “Simulation” process defined above.

After treatment planning has been accomplished the actual recurring, e.g., daily, weekly, monthly, etc., treatment of the patient is undertaken. That activity entails bringing the components that are to be used in the treatment into the room with the patient. In particular, the reader of the system interrogates the various components, whereupon the computer system and its associated software and database determine if all of the desired components for that treatment are in the room ready for the patient. The patient herself/himself may be provided with a RFID tag, e.g., a bracelet, identifying who the patient is to enable the system to conduct the verification process in response to detection of the patient's RFID tag. The clinical documentation of the setup of the components for the treatment can then be recorded by the system. Alternatively, it may be recorded by the therapist through a physical or electronic chart. It should be pointed out at this juncture that while the system described above discusses writing data to the RFID tags, that capability is not necessary for many applications. Thus, for some applications, each of the RFID tags can be a read-only device, e.g., preprogrammed with a unique identifier and type of device at the factory making the tag. Moreover, each tag may be provided with encryption to ensure system security.

As should be appreciated from the foregoing the verification system of this invention enables one to properly align, assign, verify and document all components used during a clinical treatment. For example, transportation or pre-treatment set up couches and/or other positioning devices and/or treatment aids can be accounted for once they are placed on the treatment stand or treatment couchtop by a reader positioned in the room or at the foot of the couch/pedestal. The information in the RFID tags verifies proper patient association and use of all positioning and therapy devices associated with the patient. This verification information can be displayed and recorded by third party “Record and Verify” software. Moreover, all RFID tagged treatment aids and positioning products brought into the vicinity of the reader, whether they are custom or multi-use, will be automatically read and input into the system for verification and documentation purposes, e.g., providing a clinical record that documents each treatment, the equipment used and its accuracy relative to the physician's prescription. Further still, the system of this invention can utilize the input from the various RFID tags to determine the time that a patient and/or personnel and/or appropriate component(s) spend(s) at a given location for a particular treatment so that the patient waiting time or treatment time can be examined and potentially reduced, thereby improving patient satisfaction and improving treatment throughput. To that end, the computer system and its software is arranged to analyze the local and temporal information received from the network of transmitters/receivers to compare against a set of previously stored transmitter/receiver localities (e.g., transmitter/receiver department map) to provide temporal and local tracking information regarding the facility's patients, personnel and tagged components within the facility.

The system of this invention enables one determine the location of all of the patents, facility staff or personnel and appropriate components for each particular patient's treatment so that all that is needed to insure that the treatment can proceed are in place or can be located prior to treatment and put in place. The system of this invention also enables one determine the time that a particular patient or staff or component spends at a given location for a particular treatment so that the patient waiting time or treatment time can be examined and potentially reduced, thereby improving patient satisfaction and treatment throughput.

While the invention has been described in detail and with reference to specific embodiments thereof, it will be apparent to one skilled in the art that various changes and modifications can be made therein without departing from the spirit and scope thereof.

What is claimed is:

1. A system for providing at least one radiation therapy treatment to a patient in a facility by means of a radiation therapy apparatus, said system comprising:
at least one component specifically selected for use by the patient when undergoing the at least one radiation therapy treatment, said component having a RFID tag secured thereto, said RFID tag being arranged to hold information relevant to said component therein;
a first wireless device comprising a transmitter and a receiver, said transmitter being arranged for sending a wireless signal into the area of the facility at which the radiation therapy apparatus is located and said at least one component may be located, said RFID tag of said at least one component being arranged to transmit a wireless signal representative of said at least one component in response to said wireless signal from said transmitter;
said receiver being arranged for wirelessly receiving said wireless signal from said RFID tag of said at least one component and providing a signal in response thereto; and
a database in a computer system coupled to said first wireless device, said database including information about the patient and said at least one component, said computer system being arranged to utilize said database and said signal from said receiver in order to determine if said at least one component is present to enable the desired radiation therapy treatment to be given to the patient.

2. The system of claim 1, wherein said computer system is arranged to utilize said database and said signal from said reader to determine if said at least one component has been provided into the area of the facility at which the radiation therapy apparatus to be used with the patient is located.

3. The system of claim 2 wherein said computer system is arranged to utilize said database and said signal from said receiver to determine the temporal status of said at least one component within the facility.

4. The system of claim 2 wherein said computer system is arranged to utilize said database and said signal from said receiver to determine the location of said at least one component within the facility.

5. The system of claim 1 wherein the radiation therapy apparatus is located within a room in the facility, the facility having at least one other room in which said at least one component can be located, and wherein said system additionally comprises a second wireless device, said second wireless device comprising a transmitter and a receiver, said transmitter of said second wireless device being arranged for sending a wireless signal into the at least one other room, said RFID tag of said at least one component being arranged to transmit a wireless signal representative of said at least one component in response to said wireless signal from said transmitter of said second wireless device, said receiver of said second wireless device being arranged for wirelessly receiving said wireless signal from said RFID tag of said at least one component and providing a signal in response thereto, said computer system being arranged to utilize said database and said signals from said receivers of said first and second wireless devices to determine the location of said at least one component in either of the rooms of the facility and/or the temporal status of said at least one component in either of the rooms of the facility.

6. The system of claim 1 wherein the radiation therapy apparatus is located within a room in the facility, the facility having at least one other room in which the patient may be located, and wherein said system additionally comprises a second wireless device, said second wireless device comprising a transmitter and a receiver, said transmitter of said second wireless device being arranged for sending a wireless signal into the at least one other room, said receiver of said second wireless device being arranged for wirelessly receiving said wireless signal from said RFID tag of said at least one component and providing a signal in response thereto, said system additionally comprising an RFID tag to be disposed on the patient and arranged to transmit a wireless signal representative of the patient in response to said wireless signal from said transmitter of said first wireless device and in response to said wireless signal from said second wireless device, said receiver of said first wireless device being arranged for wirelessly receiving said wireless signal from said RFID tag disposed on the patient and providing a signal in response thereto, said receiver of said second wireless device being arranged for wirelessly receiving said wireless signal from said RFID tag disposed on the patient and providing a signal in response thereto, wherein said computer system is arranged to utilize said database and said signals from said receivers of said first and second wireless devices to determine the location of the patient in either of the rooms of the facility and/or the temporal status of the patient in either of the rooms of the facility.

7. The system of claim 1 wherein the radiation therapy apparatus is located within a room in the facility, the facility having at least one other room in which a staff person of the facility may be located, and wherein said system additionally comprises a second wireless device, said second wireless device comprising a transmitter and a receiver, said transmitter of said second wireless device being arranged for sending a wireless signal into the at least one other room, said receiver of said second wireless device being arranged for wirelessly receiving said wireless signal from said RFID tag of said at least one component and providing a signal in response thereto, said system additionally comprising an RFID tag to be disposed on the staff person and arranged to transmit a wireless signal representative of the staff person in response to said wireless signal from said transmitter of said first wireless device and in response to said wireless signal from said second wireless device, said receiver of said first wireless device being arranged for wirelessly receiving said wireless signal from said RFID tag disposed on the staff person and providing a signal in response thereto, said receiver of said second wireless device being arranged for wirelessly receiving said wireless signal from said RFID tag disposed on the staff person and providing a signal in response thereto, wherein said computer system is arranged to utilize said database and said signals from said receivers of said first and second wireless devices to determine the location of the staff person in either of the rooms of the facility and/or the temporal status of the patient in either of the rooms of the facility.

8. The system of claim 1 comprising plural components to be used with the patient, each of said components having a respective RFID tag secured thereto, each of said RFID tags holding information relating to the specific component to which said tag is secured.

9. The system of claim 8 wherein said computer system is arranged to analyze the information received from said components to compare it against a set of previously stored data.

10. The system of claim 8 wherein said computer system determines if all of the appropriate components for the patient for a particular treatment are in place so that the treatment can proceed according to a treatment plan.

11. The system of claim 1 wherein said system is arranged to write new data to the at least one RFID tag.

12. The system of claim 1 wherein said database includes one or more of the group of data comprising the patient's name, the patient's identification number, the patient's consent signature or treatment verification sign off, the patient's photograph, the patient's fingerprint, any other patient identifier, the patient's address, the patient's telephone number, the patient's record and verification information, the patient's diagnosis, the identity of the medical personnel caring for the patient, the signature of the any of the medical personnel caring for the patient, patient treatment planning data, treatment alignment data, the treatment component list, equipment set up data, patient positioning or indexing data, the identification of treatment room, the treatment number, the cumulative radiation dose, the treatment time, patient specific imaging and contour data, and patient billing information.

13. The system of claim 1 wherein said RFID tag is fixedly secured to said at least one component.

14. The system of claim 1 wherein said receiver is arranged to be located in the wall, ceiling or floor of the facility.

15. The system of claim 1 wherein said receiver is located at a table for supporting the patient adjacent the radiation therapy apparatus.

16. A method for determining if at least one predetermined component has been provided with a patient to enable the patient to undergo at least one radiation therapy treatment using that component, the radiation therapy being provided to the patient by radiation therapy apparatus in a predetermined room in a facility, said method comprising:
providing at least one component specifically selected for use with the patient when undergoing the at least one radiation therapy treatment, said at least one component having a RFID tag fixedly secured thereto, said RFID tag being arranged to hold information relevant to said at least one component;
providing a first wireless device comprising a transmitter and a receiver, said transmitter being arranged for sending a wireless signal into the room of the facility at which the radiation therapy apparatus is located to cause said RFID tag of said at least one component if located therein to transmit a wireless signal representative of said at least one component, said receiver being arranged for wirelessly receiving said wireless signal from said RFID tag of said at least one component and providing a signal in response thereto;
providing a database in a computer system coupled to said receiver, said database including information about said patient and said at least one component; and
utilizing said database and said signal from said receiver in said computer system, whereupon said computer system can determine if said at least one component has been provided in the predetermined room to be used with the patient when the patient will be undergoing said radiation therapy by the radiation therapy apparatus therein.

17. The method of claim 16 wherein the facility includes at least one other room in the facility at which said at least one component may be located, and wherein said method additionally comprises:
providing a second wireless device comprising a transmitter and a receiver, said transmitter of said second wireless device being arranged for sending a wireless signal into the at least one other room of the facility to cause said RFID tag of said at least one component to transmit a wireless signal representative of said at least one component, said receiver of said second wireless device being arranged for wirelessly receiving said wireless signal from said RFID tag of said at least one component and providing a signal in response thereto;
utilizing said database and said signals from said receivers of said first and second devices, whereupon said computer system can determine the determine the location of said at least one component in either of the rooms of the facility and/or the temporal status of said at least one component in either of the rooms of the facility.

18. A method of tracking a patient in a facility at which the patient will be given at least one radiation therapy treatment by a radiation therapy apparatus located in a room of the facility, said method comprising:
providing a RFID tag on the patient, said RFID tag being arranged to hold information relevant to the patient therein;
providing a first wireless device comprising a transmitter and a receiver, said transmitter being arranged for sending a wireless signal into the room of the facility to cause said RFID tag on the patient to transmit a wireless signal representative of the patient, said receiver being arranged for wirelessly receiving said wireless signal from said RFID tag on the patient and providing a signal in response thereto;
providing a database in a computer system coupled to said receiver, said database including information about the patient and the room of the facility; and
utilizing said database and said signal from said receiver in said computer system, whereupon said computer system can determine the location of the patient in the rooms of the facility and/or the temporal status of the patient in the room of the facility.

19. The method of claim 18, wherein the facility includes at least one other room of the facility at which the patient may be located, wherein said database includes information about the at least one other room of the facility and wherein said method additionally comprises:
providing a second wireless device comprising a transmitter and a receiver, said transmitter of said second wireless device being arranged for sending a wireless signal into the at least one other room of the facility to cause said RFID tag on the patient to transmit a wireless signal representative of the patient, said receiver of said second wireless device being arranged for wirelessly receiving said wireless signal from said RFID tag on the patient and providing a signal in response thereto; and
utilizing said database and said signals from said receivers of said first and second wireless devices, whereupon said computer system can determine the location of the patient in either of the rooms of the facility and/or the temporal status of the patient in either of the rooms of the facility.

20. A method of tracking a staff person in a facility at which a patient will be given at least one radiation therapy treatment by a radiation therapy apparatus located in a room in the facility, said method comprising:
providing a RFID tag on the staff person, said RFID tag being arranged to hold information relevant to the staff person therein;
providing a first wireless device comprising a transmitter and a receiver, said transmitter being arranged for sending a wireless signal into the room of the facility to cause said RFID tag on the staff person to transmit a wireless signal representative of the staff person, said receiver being arranged for wirelessly receiving said wireless signal from said RFID tag on the staff person and providing a signal in response thereto;
providing a database in a computer system coupled to said receiver, said database including information about the staff person and the room of the facility; and
utilizing said database and said signal from said receiver in said computer system, whereupon said computer system can determine the location of the staff person in the room of the facility and/or the temporal status of the staff person in the room of the facility.

21. The method of claim 20, wherein the facility includes at least one other room of the facility at which the staff person may be located, wherein said database includes information about the at least one other room in the facility and wherein said method additionally comprises:
providing a second wireless device comprising a transmitter and a receiver, said transmitter of said second wireless device being arranged for sending a wireless signal into the at least one other room of the facility to cause said RFID tag on the staff person to transmit a wireless signal representative of the staff person, said receiver of said second wireless device being arranged for wirelessly receiving said wireless signal from said RFID tag on the staff person and providing a signal in response thereto; and
utilizing said database and said signals from said receivers of said first and second wireless devices, whereupon said computer system can determine the location of the staff person in either of the rooms of the facility and/or the temporal status of the staff person in either of the rooms of the facility.

22. The method of claim 16 wherein plural components are to be used with the patient, each of said components having a respective RFID tag secured thereto, each of said RFID tags being arranged to hold information relevant to the specific component to which said RFID tag is secured.

23. The method of claim 22 wherein said computer system is arranged to analyze the information received from said components to compare it against a set of previously stored data and/or conditions.

24. The method of claim 22 wherein the database includes one or more of the group of data comprising the patient's name, the patient's identification number, the patient's consent signature or treatment verification sign off, the patient's photograph, the patient's fingerprint, any other patient identifier, the patient's address, the patient's telephone number, the patient's record and verification information, the patient's diagnosis, the identity of the medical personnel caring for the patient, the signature of the any of the medical personnel caring for the patient, patient treatment planning data, treatment alignment data, the treatment component list, equipment set up data, patient positioning or indexing data, the identification of treatment room, the treatment number, the cumulative radiation dose, the treatment time, patient specific imaging and contour data, and patient billing information.
